(19) United States
(12) Patent Application Publication
(10) Pub. No.: US 2024/0242905 A1
(43) Pub. Date: Jul. 18, 2024

(54) AN INTEGRATED THREE POSITION ROCKER SWITCH

(71) Applicants: UNO Minda Limited, Gurgaon, Haryana (IN); Harley-Davidson Motor Company, Inc., Milwaukee, WI (US)

(72) Inventors: Surender RANA, Gurgaon, Haryana (IN); Rahul SAHNI, Gurgaon, Haryana (IN); Manmeet SINGH, Gurgaon, Haryana (IN); Benjamin HYNES, Milwaukee, WI (US); Matt TAYLOR, Milwaukee, WI (US); Trisha BAIRD, Milwaukee, WI (US); Patrick MCKEON, Milwaukee, WI (US)

(73) Assignees: UNO Minda Limited, Gurgaon, Haryana (IN); Harley-Davidson Motor Company, Inc., Milwaukee, WI (US)

(21) Appl. No.: 18/559,619

(22) PCT Filed: May 6, 2022
(86) PCT No.: PCT/IN2022/050441

§ 371 Date: Nov. 8, 2023

(30) Foreign Application Priority Data
May 8, 2021 (IN) 202111020931

(51) Int. Cl. H01H 23/28; B60Q 1/14; H01H 23/04; H01H 23/20

(52) U.S. Cl. CPC H01H 23/28; B60Q 1/1446; H01H 23/04; H01H 23/205

(57) ABSTRACT

An integrated three position rocker switch for vehicles comprises a housing configured to support one or more components of the switch, a knob assembly, a first micro-switch, a second micro-switch and knob. The knob assembly is disposed in the housing, wherein the knob assembly comprises a knob pivotally supported in the housing, and a plunger coupled with the knob through a resilient member. The first micro-switch is coupled with the knob assembly in the housing, and the second micro-switch is disposed in the housing in vicinity of the first micro-switch. The knob is configured to move in multiple positions for actuating the first and second micro-switches to perform more than one operation.

### FIELD OF DISCLOSURE

The present disclosure generally relates to the field of automobiles. Particularly, the present disclosure relates to an integrated three position rocker switch for vehicles. Further, embodiments of the present disclosure disclose the construction and mechanism of an integrated three position rocker switch.

### BACKGROUND

The information in this section merely provides background information related to the present disclosure and may not constitute prior arts:

Generally, vehicles such as, but not limited to, two-wheelers, are equipped with switches such as turn indicator switches, head lamp switches, engine kill switches etc, for operating the various electronic functions of the vehicle. One such switch is a dimmer switch (100) configured to regulate the headlamp of the vehicle. Conventionally, the functions of high beam and low beam is achieved by means of a singular switching device having a knob and in case of an EKS switch, the functions of ON and OFF is achieved by means of a singular switching device having a Knob. For achieving the pass function, the rider has to separately activate the ‘pass’ switch provided on the handlebar of the vehicle. Another example of one such switch is the EKS switch configure to ON/OFF an engine of a vehicle. The functions of ON and OFF is achieved by means of a singular switching device having a Knob. For achieving the Self-Start function, the rider has to separately activate the ‘Self-Start’ switch provided on the handlebar of the vehicle.

A major drawback associated with the conventional switches, as shown in FIG. 1(a), is that the switch is configured to provide a single function on each position. Thus, an extra switch is required to be mounted on the handlebar of the vehicle for achieving pass or Self-Start function. The operation of a separate pass switch or a self-start switch is inconvenient for the rider and may cause distraction while riding the vehicle. It also increases the number of components making the assembly complex and expensive. Another type of conventional switch is a dimmer with pass switch having a single knob to perform low beam, high beam, and pass function in a vehicle. The switch includes single microswitch to perform the said three function. The drawback in the said dimmer with pass switch is if the microswitch fails during the operation, it leads to failure of the switch and ultimately fails to perform an important function of the vehicle. The failure to perform an important function of the vehicle may lead to accident or stopping of the vehicle. The above-described switches fail to discuss about the functional safety requirement of a switch.

Accordingly, there is need in the art to develop a single switching device with functional safety that overcomes the one or more limitations associated with the prior art.

### SUMMARY OF DISCLOSURE

The present disclosure relates to construction of an integrated three position rocker switch for a vehicle, preferably for two-wheelers. Further, the solution is also cost effective as it does not require dedicated switches to perform distinct operations.

The limitations of the prior arts are addressed to a great extent by an integrated three position rocker switch for a vehicle, as disclosed in the present disclosure.

The present disclosure provides an integrated three position rocker switch. In an embodiment, the integrated three position rocker switch is a dimmer switch for vehicles. The switch comprising a housing configured to support one or more components of the switch, a knob assembly, a first micro-switch, a second micro-switch and knob. The knob assembly is disposed in the housing, wherein the knob assembly comprising a knob pivotally supported in the housing, and a plunger coupled with the knob through a resilient member. The first micro-switch is coupled with the knob assembly in the housing, and the second micro-switch is disposed in the housing in vicinity of the first micro-switch. The knob is configured to move in multiple positions for actuating the first and second micro-switches to perform more than one operation.

In an embodiment, the knob is adapted to move in three positions for actuating the first and second micro-switches to perform ‘high beam’, ‘low beam’ and ‘pass’ operations.

In an embodiment, the knob assembly comprising a first protrusion and a second protrusion configured to be engaged with the first and second micro-switches in accordance with the movement of the knob for actuating the first and second micro-switches.

In an embodiment, the resilient member is a spring configured to secure the plunger in the knob assembly, the plunger is loaded in the longitudinal direction by the spring.

In an embodiment, the knob assembly comprising a pocket provided at the bottom of the knob assembly, the pocket is adapted to accommodate the plunger and the spring.

In an embodiment, the housing comprising a pivot configured to movably support the knob by means of the plunger and the spring.

In an embodiment, the housing defines a hollow space to accommodate the first micro-switch, the second micro-switch and the knob assembly.

In an embodiment, a first cover is snap fitted with the housing to secure the position of the second micro-switch after module assembly.

In an embodiment, a second cover is snap fitted with housing for securing the positioning of the first micro-switch and the knob assembly in position after module assembly.

In an embodiment, the housing comprising a detent profile configured to support the knob assembly and a lock profile.

Further, the switch comprising a housing configured to support one or more components of the switch, a knob assembly, a first micro-switch, a second micro-switch and knob. The knob assembly is disposed in the housing, wherein the knob assembly comprising a knob pivotally supported in the housing, a plunger coupled with the knob through a resilient member, and a lever mounted on the knob assembly in vicinity of the knob. The first micro-switch is coupled with the knob assembly in the housing, and the second micro-switch is disposed in the housing in vicinity of the first micro-switch. The knob is configured to move in multiple positions for actuating the first and second micro-switches to perform more than one operation.

In an embodiment, the lever is configured to be engaged with the first micro-switch for actuating the first micro-switch with the movement of the knob.

In an embodiment, the plunger is configured to be engaged with the second micro-switch for actuating the second micro-switch with the movement of the knob.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects and features described above, further aspects and features will become apparent by reference to the drawings and the following detailed description.

### BRIEF DESCRIPTION OF FIGURES

Further aspects and advantages of the present invention will be readily understood from the following detailed description with reference to the accompanying figures. The figures together with a detailed description below, are incorporated in and form part of the specification, and serve to further illustrate the embodiments and explain various principles and advantages, in accordance with the present invention wherein:

FIG. 1(a) illustrate a perspective view of the existing switch.

FIG. 2 illustrates an exploded view of a dimmer switch for vehicles in accordance with an embodiment of the present disclosure.

FIG. 3 illustrates a perspective view of a housing of the dimmer switch for vehicles in accordance with an embodiment of the present disclosure.

FIG. 4 illustrates a perspective view of a second cover of the dimmer switch in accordance with an embodiment of the present disclosure.

FIG. 5 illustrates a perspective view of a knob of dimmer switch in accordance with an embodiment of the present disclosure.

FIG. 6 illustrates a perspective view of a first cover of dimmer switch in accordance with an embodiment of the present disclosure.

FIG. 7 illustrates an exploded view of a dimmer switch in accordance with another embodiment of the present disclosure.

FIG. 8 illustrates a sectional view of the dimmer switch in accordance with another embodiment of the present disclosure.

FIG. 9 illustrates a side view of the dimmer switch in accordance with another embodiment of the present disclosure.

FIG. 10 illustrates a perspective view of the housing of dimmer switch in accordance with another embodiment of the present disclosure.

FIG. 11 illustrates a perspective view of the second cover of the dimmer switch in accordance with another embodiment of the present disclosure.

FIG. 12 illustrates a perspective view of the knob of the dimmer switch in accordance with another embodiment of the present disclosure.

FIG. 13 illustrates a perspective view of the first cover of the dimmer switch in accordance with another embodiment of the present disclosure.

FIGS. 14(a), 14(b) and (14(c) illustrate the assembling of process of the dimmer switch in accordance with an embodiment of the present disclosure.

FIGS. 15(a), 15(b) and 15(c) illustrate the assembling of process of the dimmer switch in accordance with an embodiment of the present disclosure.

FIGS. 16(a), 16(b) and 16(c) illustrate the three positions of the knob assembly in accordance with an embodiment of the present disclosure.

FIGS. 17(a), 17(b) and 17(c) illustrate the three positions of the knob assembly in accordance with another embodiment of the present disclosure.

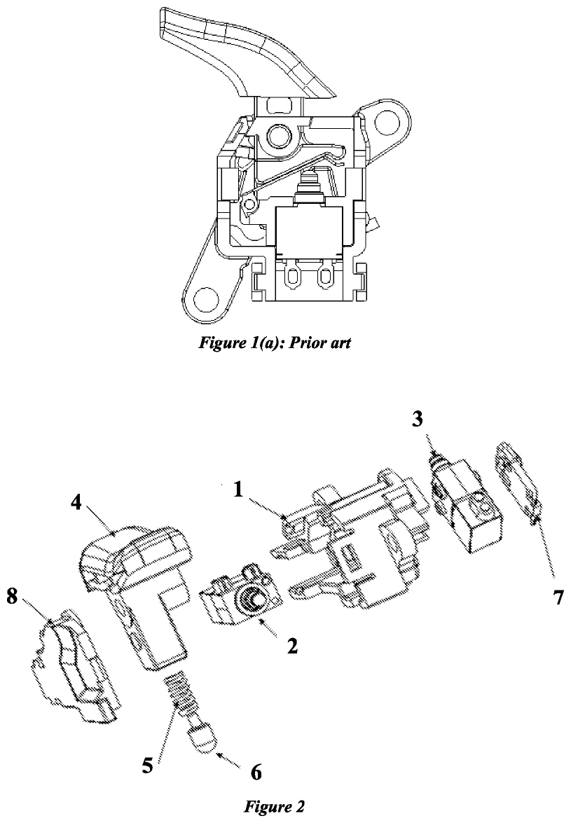

Skilled artisans will appreciate that elements in the drawings are illustrated for simplicity and have not necessarily been drawn to scale. For example, the dimensions of some of the elements in the drawings may be exaggerated relative to other elements to help to improve understanding of embodiments of the present invention.

### DETAILED DESCRIPTION

While the invention is susceptible to various modifications and alternative forms, specific embodiment thereof has been shown by way of example in the figures and will be described in detail below. It should be understood, however that it is not intended to limit the invention to the particular forms disclosed, but on the contrary, the invention is to cover all modifications, equivalents, and alternative falling within the spirit and the scope of the invention.

Before describing in detail embodiments, it may be observed that the novelty and inventive step that are in accordance with the present disclosure resides in an integrated three position rocker switch. It is to be noted that a person skilled in the art can be motivated from the present disclosure and modify the various constructions of assembly, which are varying from vehicle to vehicle. However, such modification should be construed within the scope and spirit of the invention. Accordingly, the drawings are showing only those specific details that are pertinent to understanding the embodiments of the present invention so as not to obscure the disclosure with details that will be readily apparent to those of ordinary skill in the art having benefit of the description herein.

The terms “comprises”, “comprising”, or any other variations thereof, are intended to cover a non-exclusive inclusion, such that a setup, device that comprises a list of components does not include only those components but may include other components not expressly listed or inherent to such setup or device. In other words, one or more elements in a system or apparatus proceeded by “comprises a” does not, without more constraints, preclude the existence of other elements or additional elements in the system or apparatus. The following paragraphs explain present disclosure. The disclosure in respect of the same may be deduced accordingly.

The present disclosure provides an integrated three position rocker switch for vehicles. The integrated three position rocker switch is a low amperage dimmer switch for vehicles, wherein the dimmer switch comprising a housing configured to support the one or more components of the dimmer switch, a first micro-switch, a second micro-switch and a knob assembly. The first and second micro-switches are disposed in the housing. The knob assembly comprises a knob being pivotally supported in the housing. The knob is configured to operate the first and second micro-switches. The knob assembly has a pocket to accommodate a plunger and spring. The plunger is coupled with the knob by the spring wherein the plunger is movable in a longitudinal direction. Further, a second cover is provided to cover the knob assembly and a first cover is provided cover the housing of the dimmer switch. The first and a second micro-switches are configured for providing a three-position circuit by means of a knob that is capable of moving between three positions. Thus, the dimmer switch of present disclosure provided for regulating ‘high beam’, ‘low beam’ and ‘pass’ functions by means of a single switch that can be easily operated by the user. Herein, the terms “integrated three position rocker switch”, “dimmer switch” and “switch” are used alternatively. In an embodiment, a lever is configured to operate one of the first and second micro-switches. In another embodiment, the switch is provided for performing multiple function by a single knob may be a dimmer with pass switch, an Ethernet (EKS) switch, cruise control switch or any switch performing a similar kind of functions.

Accordingly, the integrated three position rocker switch described with reference to the figures and specific embodiments; this description is not meant to be constructed in a limiting sense. Various alternative embodiments from part of the present disclosure.

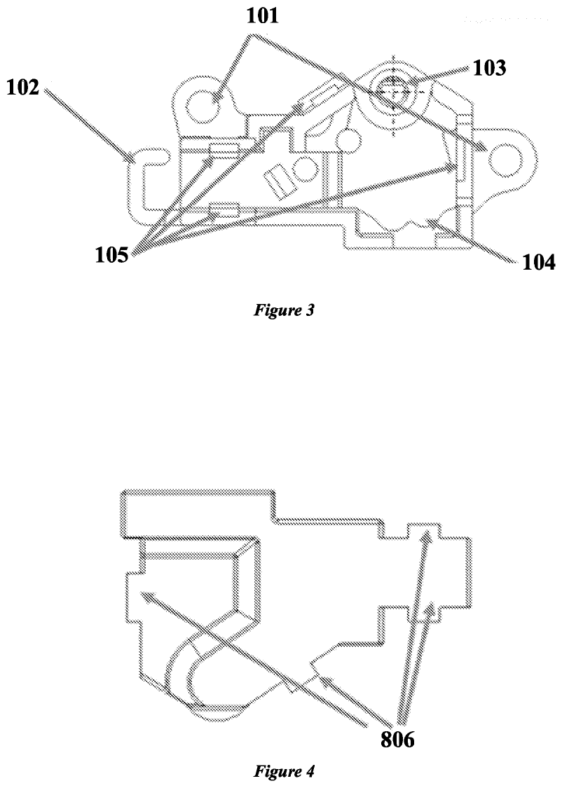

Now, referring to FIGS. 2 to 6, which illustrates the dimmer switch (100) in accordance with the first embodiment of the present disclosure. The dimmer switch (100) comprises a housing (1) configured to support one or more components of the dimmer switch (100), a first micro-switch (2), a second micro-switch (3) and a knob assembly (4). The hosing (1) defines a hollow space to accommodate one or more components of the dimmer switch (100). The first and second micro-switches (2, 3) are disposed in the housing (1). The knob assembly (4) comprises a knob (406), a plunger (6) and spring (5), wherein the knob (406) is configured to operate the first and second micro-switches (2, 3). The housing (1) has a module mounting leg (101), a wire guide (102), a pivot (103) configured for providing the movement to the knob (406) by means of the plunger (6) and the spring (5), a detent profile (104) configured for supporting the knob assembly (4) and a lock profile (105) of the switch (100). The module mounting leg (101) are provided for the mounting of the dimmer switch (100) on any surface of the vehicle. In an embodiment, the housing (1) is a bracket. In another embodiment, the housing (1) is made of metallic material. In one more embodiment, all the components are secured in the housing (1) with snap locks.

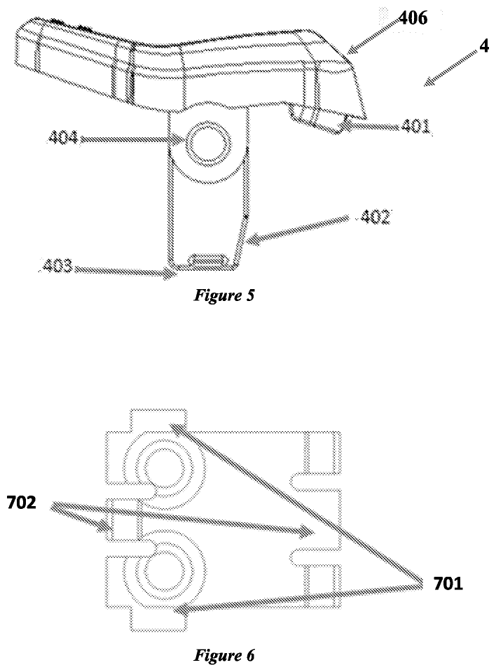

The knob assembly (4) comprises a knob (406) being pivotally supported in the housing (1), wherein the knob (406) is configured to operate the first and second micro-switches (2, 3). The knob assembly (4) has a first protrusion (401), a second protrusion (402), a pocket (403) and pivoting hole (404) as shown in FIG. 5. The pocket (403) is hollow space provided at the bottom of the knob assembly (4) and, the pocket (403) is configured to accommodate the plunger (6) and spring (5). The plunger (6) is coupled with the knob (406) by the spring (5), wherein the plunger (6) is movable in the longitudinal direction. Further, the pivoting hole (404) is provided the pivot actuation of the knob (406) upon the application of force applied by the user.

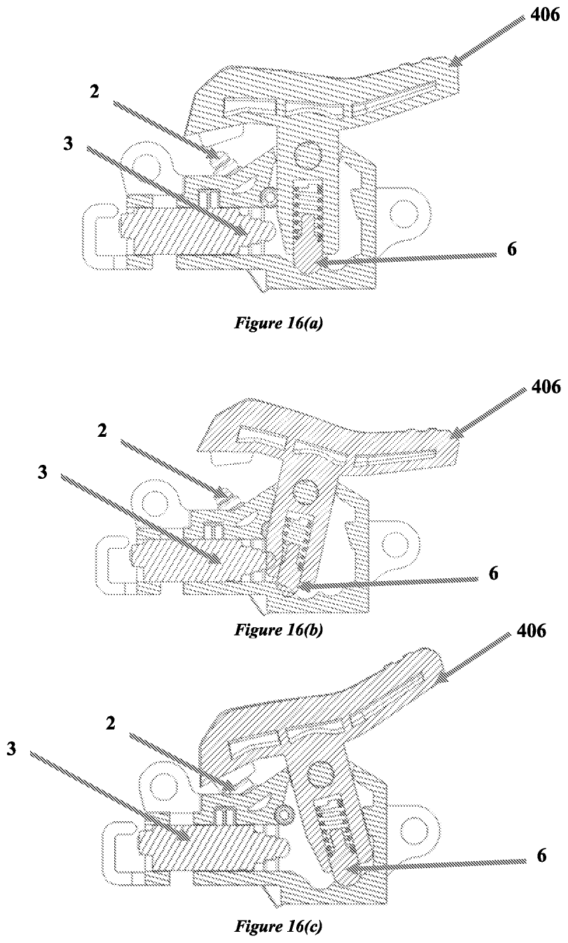

The first micro-switch (2) is coupled with the knob assembly (4) in the housing (1), wherein the first micro-switch (2) is disposed in the housing (1). The second micro-switch (3) is disposed in the housing in vicinity of the first micro-switch (2). In an embodiment, the second micro-switch (3) is mounted on the housing (1) on opposite end from the mounting of the first micro-switch (2). The knob (406) is configured to move in multiple positions for actuating the first and second micro-switches (2, 3) to perform more than one operation. In an embodiment, the knob is adapted to move in three positions as shown in FIG. 16, for actuating the first and second micro-switches (2, 3) to perform ‘high beam’, ‘low beam’ and ‘pass’ operations. FIG. 16(a) illustrates the position of knob while performing the function of ‘low beam’, FIG. 16(b) illustrates the position of knob (406) while performing the function of ‘pass’, and FIG. 16(c) illustrates the position of knob (406) while performing the function of ‘high beam’. In an embodiment, the first and second micro-switches (2, 3) are further connected with a control unit for communicating that the switch (100) is working or not-working as per Functional Safety Requirement (FSR).

As shown in FIG. 4, a first cover (7) is provided to cover the housing (1) of the dimmer switch (100), and a second cover (8) is provided to cover the knob assembly (4). The second cover (8) is snap fitted with housing (1) for ensuring the first micro-switch (2) and knob assembly (4) in their place after module assembly. The second cover (8) has a plurality of snap locks (806) configured to engage with the housing (1). Further, the first cover (7) has a first recess (701) and a second recess (702) configured to be fitted in the housing (1), as shown in FIG. 6. Thus, the first cover (7) is snap fitted with the housing (1) for ensuring the second micro-switch (3) in its place after module assembly. In an embodiment, the second micro-switch (3) is covered by the first cover (7). The second micro-switch (3) is sealed by the first cover (7) as per the FSR.

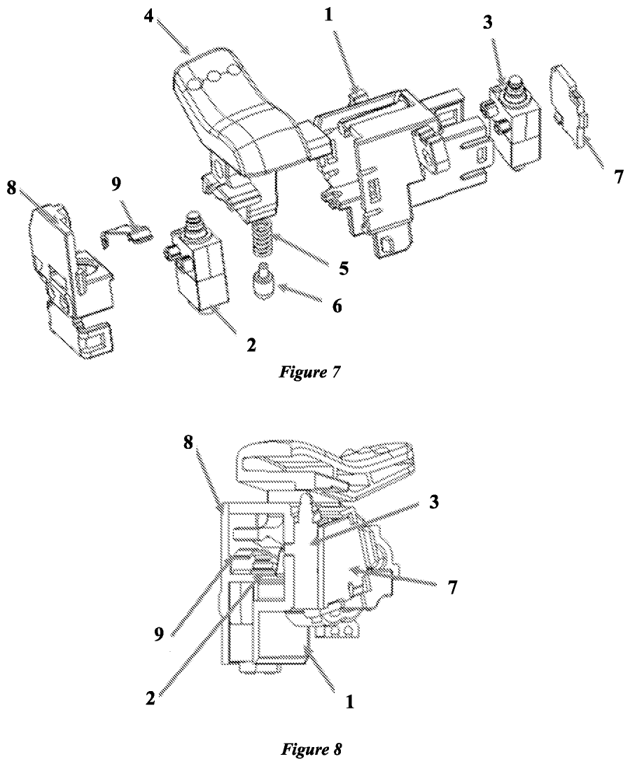

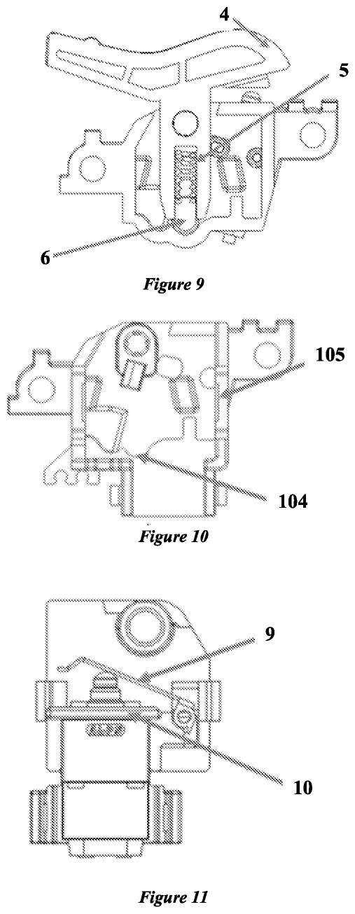

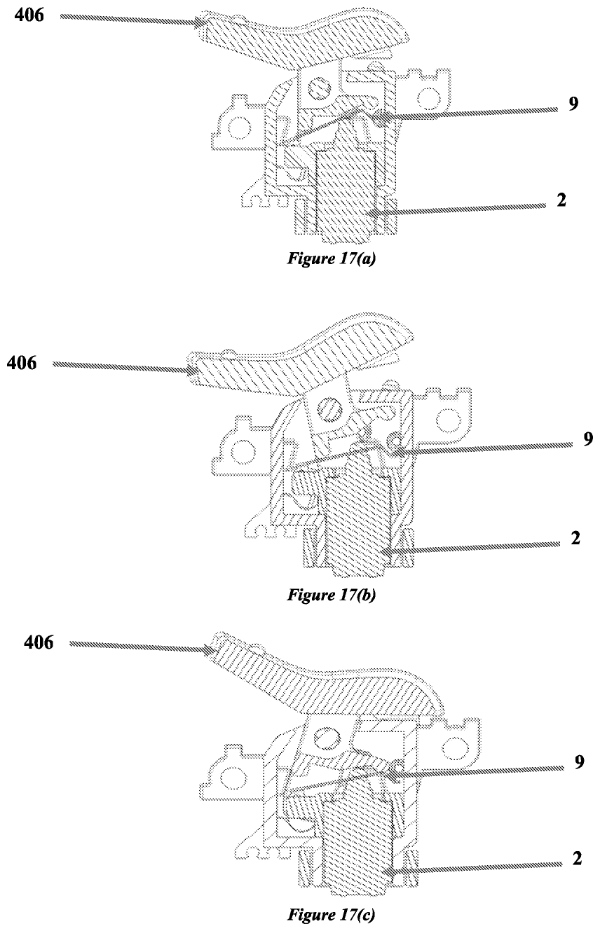

Referring to the FIGS. 7-13, which illustrates the dimmer switch (100) in accordance with the second embodiment of the present disclosure. Herein, the dimmer switch (100) having all components same as of first embodiment, except an addition component that is a lever (9). Herein, the knob assembly (4) comprises a knob (406), a plunger (6) and spring (5), wherein the knob assembly (4) is attached with the housing (1). The first micro-switch (2) is mounted on the second cover (8). The lever (9) is attached with the second cover (8) and, the lever (9) is configured to be engaged with the first micro-switch (2) mounted on the second cover (8) for actuating the first micro-switch (2). The second cover (8) is snap fitted with the housing (1) to ensure that the first micro-switch (2) and knob assembly (4) are their place after module assembly. The second micro-switch (3) is connected with housing (1) on opposite end from the knob assembly (4). The first cover (7) is mounted on housing (1) to secure the second micro-switch (3). In second embodiment as shown in FIGS. 17(a), 17(b) and 17(c), the knob (406) is adapted to move in three positions for actuating the first and second micro-switches (2, 3) to perform ‘high beam’, ‘low beam’ and ‘pass’ operations. FIG. 17(a) illustrates the position of knob (406) while performing the function of ‘low beam’, and FIG. 17(b) illustrates the position of knob (406), wherein the plunger (6) engages with the second micro-switch (3) and the switch (100) is performing the function of ‘pass’. Further, FIG. 17(c) illustrates the position of knob (406), wherein the lever (9) engages with the first micro-switch (2) and the switch (100) is performing the function of ‘high beam’

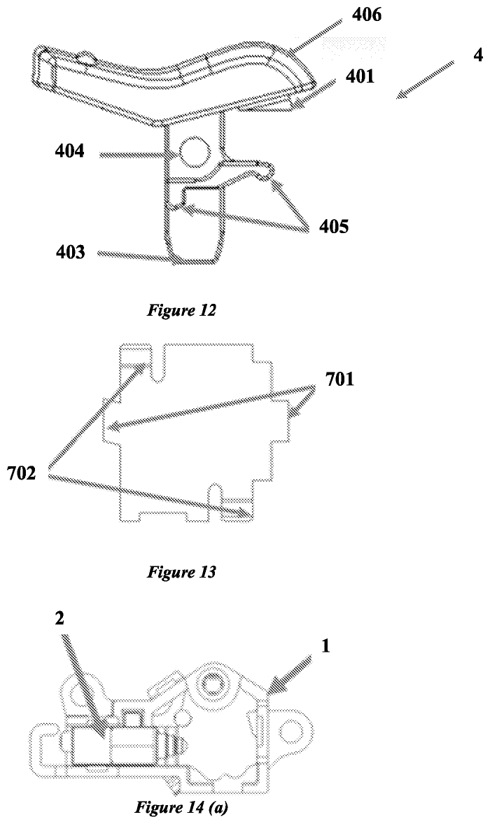

As shown in FIG. 11, the second cover (8) of second embodiment, has a mounting member (10) configured for placing the first micro-switch (2). The second cover (8) accommodates the lever (9) to be engaged with the first micro-switch (2) for actuating the first micro-switch (2) with the movement of the knob. Further, the plunger (6) is configured to be engaged with the second micro-switch (3) for actuating the second micro-switch (3) with the movement of the knob (406). Referring to FIG. 12, the knob assembly (4) of the second embodiment, has a lever pressing profile (405) configured to be coupled with the lever (9) for the pressing the lever (9) to actuate the first micro-switch (2).

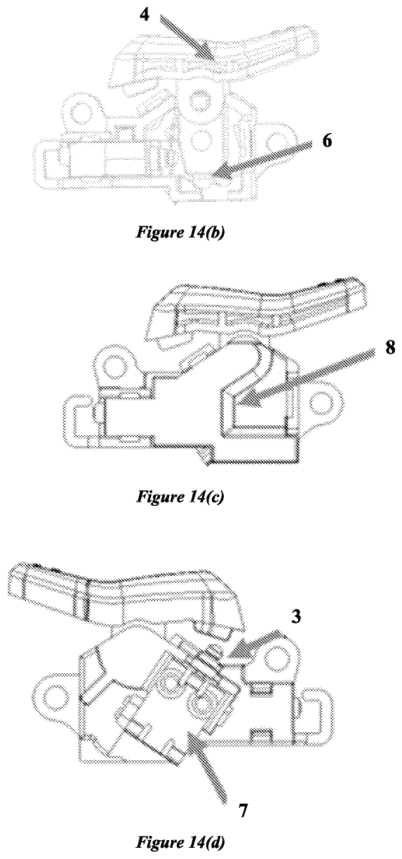

Referring to FIGS. 14(a), 14(b, 14(c) and 14(d) which illustrate the assembling process of the dimmer switch (100) in accordance with an embodiment of the present disclosure. The assembling process of dimmer switch (100) comprises a disposing of the first micro-switch (2) in the housing (1), coupling of the knob assembly (4) with housing (1) and insertion of the spring (5) and plunger (6) in the knob assembly (4) coupled with the housing (1). Further, the second micro-switch (3) is connected with the housing (1) and the second cover (8) is mounted on the housing (1) for securing the position of the first micro-switch (2) and the knob assembly (4). Moreover, the second micro-switch (3) is connected with housing (1) on opposite end from the mounting of the first micro-switch and, the first cover (7) is mounted to secure the second micro-switch (3).

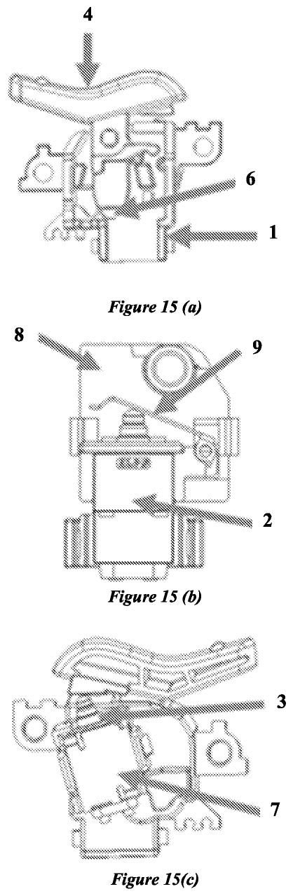

Referring to FIGS. 15(a), 15(b) and 15(c) which illustrate the assembling process of the dimmer switch (100) in accordance with another embodiment of the present disclosure. The assembling process of dimmer switch (100) comprises a coupling of the knob assembly (4) with housing (1) and insertion of the spring (5) and plunger (6) in the knob assembly (4) coupled with the housing (1). Further, the process comprising the attaching of lever (9) with the second cover (8) and mounting of the first micro-switch (2) on the second cover (8). The second cover (8) is snap fitted with the housing (1) to ensure that the first micro-switch (2) and knob assembly (4) are their place after module assembly. The lever is configured to be engaged with the first micro-switch (2) mounted on the second cover (8). Moreover, the second micro-switch (3) is connected with housing (1) on opposite end from the mounting of the knob assembly (4) and, the first cover (7) is mounted to secure the second micro-switch (3).

When the user actuates the knob (406) from a first position to a third position, the plunger (6) moves in longitudinal direction to actuate the second micro-switch (3) and, alternatively, the lever (9) presses the first micro-switch (2) to actuate the first micro-switch (2). Upon release of the actuating force from knob (406), the spring (5) tends to expand or de-energize which causes movement of the plunger (6). The first and second protrusions (401, 402) are configured to be engaged with the first and second micro-switches (2, 3) with the movement of the knob for actuating the first and second micro-switches (2, 3). In an embodiment, the actuation of the first micro-switch (2) and the second micro-switch (3) takes place in alternative manner. In first position as shown in FIG. 16(a), the knob (406) is stationary condition without any force so that the switch (100) is performing the function of ‘low beam’. In second position as shown in FIG. 16(b), the knob (406) is pressed in clockwise direction so that the plunger (6) is engaged with the second micro-switch (3) and the activate the second micro-switch (3) for performing the function of ‘pass’. In third position as shown in FIG. 16(c), the knob (406) is pressed in anti-clockwise so that the lever (9) is engaged with the first micro-switch (2) and the activate the first micro-switch (2) for performing the function of ‘high beam’. The first and a second micro-switches (2, 3) are configured for providing a three-position circuit by means of a knob (406) that is capable of moving between three positions for regulating ‘high beam’, ‘low beam’ and ‘pass’ functions by means of a single switch (100) that can be easily operated by the user.

In present disclosure, the dimmer switch (100) with pass module has two separate micro-switches, each with separate switching outputs, for ensuring that the switch is working or not-working as per Functional Safety Requirement (FSR). The switching outputs include NO/NC, open or closed circuit. In accordance with the connection of the first and second micro-switches (2, 3), the first and second micro-switches (2, 3) communicate with the control unit and the, the control unit identify the working or non-working condition of the dimmer switch (100. The dimmer switch (100) has compact size as the number of parts are reduced. The switch transmits two redundant signals for single switch operation. These two signals are transmitted while the switch is activated/deactivated. The strategy used to ensure reliability of the switch is to use two signals wherein one signal is analog signal and other is CAN signal, to manage the critical nature of the switch state. The usage of redundant switch inputs increases the confidence level in determining an intentional and identifying an unintended switch transition. Both the redundant outputs are transmitted to electronic control unit for managing critical functionality of vehicle and ensure unintended activation of vehicle which may cause continuous run resulting in overheat, vehicle in run position without resulting in accident.

List of reference numerals:

| Components | Reference numerals |
|---|---|
| Switch | 100 |
| Housing | 1 |
| Module Mounting leg | 101 |
| Wire Guide | 102 |
| Pivot | 103 |
| Detent profile | 104 |
| Lock profile | 105 |
| First micro-switch | 2 |
| Second micro-switch | 3 |
| Knob assembly | 4 |
| First protrusion | 401 |
| Second protrusion | 402 |
| Pocket | 403 |
| Pivoting hole | 404 |
| Lever pressing profile | 405 |
| Knob | 406 |
| Spring | 5 |
| Plunger | 6 |
| First cover | 7 |
| First recess | 701 |
| Second recess | 702 |
| Second cover | 8 |
| Snap locks | 806 |
| Lever | 9 |
| Mounting member | 10 |

### EQUIVALENTS

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

1. An integrated three position rocker switch for vehicles, the switch comprising:
a housing configured to support one or more components of the switch;
a knob assembly disposed in the housing, the knob assembly comprising:
a knob pivotally supported in the housing;
a plunger coupled with the knob through a resilient member;
a first micro-switch coupled with the knob assembly in the housing;
a second micro-switch disposed in the housing in vicinity of the first micro-switch;
wherein the knob is configured to move in multiple positions for actuating the first and second micro-switches to perform more than one operation.

2. The switch as claimed in claim 1, wherein the knob is adapted to move in three positions for actuating the first and second micro-switches to perform ‘high beam’, ‘low beam’ and ‘pass’ operations.

3. The switch as claimed in claim 1, wherein the knob assembly comprising a first protrusion and a second protrusion configured to be engaged with the first and second micro-switches in accordance with the movement of the knob for actuating the first and second micro-switches.

4. The switch as claimed in claim 1, wherein the resilient member is a spring configured to secure the plunger in the knob assembly, the plunger is loaded in the longitudinal direction by the spring.

5. The switch as claimed in claim 1, wherein the knob assembly comprising a pocket provided at the bottom of the knob assembly, the pocket is adapted to accommodate the plunger and the spring.

6. The switch as claimed in claim 1, wherein the housing comprising a pivot configured to movably support the knob by means of the plunger and the spring.

7. The switch as claimed in claim 1, wherein the housing defines a hollow space to accommodate the first micro-switch, the second micro-switch and the knob assembly.

8. The switch as claimed in claim 1, comprising a first cover snap fitted with the housing to secure the position of the second micro-switch after module assembly.

9. The switch as claimed in claim 1, comprising a second cover snap fitted with housing for securing the positioning of the first micro-switch and the knob assembly in position after module assembly.

10. The switch as claimed in claim 1, wherein the housing comprising a detent profile configured to support the knob assembly and a lock profile.

11. An integrated three position rocker switch for vehicles, the switch comprising
a housing configured to support one or more components of the switch;
a knob assembly disposed in the housing, the knob assembly comprising:
a knob pivotally supported in the housing;
a plunger coupled with the knob through a resilient member;
a lever mounted on the knob assembly in vicinity of the knob;
a first micro-switch coupled with the knob assembly in the housing;
a second micro-switch disposed in the housing in vicinity of the first micro-switch;
wherein the knob is configured to move in multiple positions for actuating the first and second micro-switches to perform more than one operation.

12. The switch as claimed in claim 11, wherein the lever is configured to be engaged with the first micro-switch for actuating the first micro-switch with the movement of the knob.

13. The switch as claimed in claim 11, wherein the plunger is configured to be engaged with the second micro-switch for actuating the second micro-switch with the movement of the knob.
